(19) United States
(12) Patent Application Publication
(10) Pub. No.: US 2022/0277256 A1
(43) Pub. Date: Sep. 1, 2022

(54) SYSTEMS AND METHODS FOR PRODUCT DIMENSION CORRECTION

(71) Applicant: 6 River Systems, LLC, Waltham, MA (US)

(72) Inventors: Alexa MELLON, Cambridge, MA (US); Jeff KREIS, Wolfeboro, NH (US)

(21) Appl. No.: 17/187,346

(22) Filed: Feb. 26, 2021

(51) Int. Cl. G06Q 10/08; G06F 17/18

(52) U.S. Cl. CPC G06Q 10/087; G06F 17/18

(57) ABSTRACT

Disclosed are systems and methods for determining whether a product dimension has changed by continuously verifying that the product dimensions have not changed. Suspicions of product dimension changes are based on warehouse operation exceptions. Each time the computer identifies an exception, information associated with the exception is collected and stored. The suspicions of product dimension changes accrue as exceptions are identified, products associated with exceptions are monitored, and suspicion scores associated with each product involved in the exception are updated. The suspicion score is indicative of the likelihood that the product dimensions have changed. The computer may perform different actions, depending on whether one or more thresholds have been exceeded, with respect to each product.

### TECHNICAL FIELD

This application relates generally to detecting and updating product dimension changes from operational anomalies.

### BACKGROUND

Product sizes and weights may change over time, and a warehouse may not always be notified of the product dimension changes. For example, a seller may introduce new models of products into the market, discontinue old models of products, change the size and/or weight of a product or its packaging, or change the size and/or weight of a product or its packaging.

Changes of product dimension (length, height, depth, weight) may affect a cost to ship the product (e.g., weight of the shipment, size of the shipping package) or a storage location of the product in the warehouse (e.g., may not fit in shelves/bins, may be too heavy for shelves/bins), and may affect the collection of products in a warehouse for order fulfillment (e.g., the product may precariously stick out of a tote and/or the product may inefficiently consume space in the tote).

### BRIEF DESCRIPTION OF THE DRAWINGS

The accompanying drawings constitute a part of this specification and illustrate embodiments of the subject matter disclosed herein.

FIG. 1 shows a system for adaptively updating and correcting product dimension, according to an embodiment.

FIG. 2A shows a perspective view of an autonomous robot, according to an embodiment.

FIG. 2B shows a block diagram of an autonomous robot, according to an embodiment.

FIG. 2C shows a perspective view of an autonomous robot, according to an embodiment.

FIG. 3A shows execution steps of a method for identifying exceptions during warehouse operations and determining a suspicion score associated with the products involved in the exception, according to an embodiment.

FIG. 3B shows an example of actions that the analytics server may perform, according to an embodiment.

FIG. 3C shows an example of tasks performed in response to a lack of exceptions identified, according to an embodiment.

FIG. 3D shows an example of tasks performed in response to an exception identified, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

There remains a desire to maintain accurate records of product sizes and/or weights (dimensions), especially when the change of the product dimension interferes with an operation of the warehouse. A computer may maintain the accuracy of product sizes and/or weights by updating incorrect product dimensions. The computer may monitor for anomalies that occur during normal warehouse operations (e.g., exceptions that occur during normal warehouse operations) and determine whether the anomaly is a result of an incorrect product dimension (e.g., undocumented product dimension change, outdated product dimension, incorrect input of a product dimension). The computer may identify an exception by identifying irregular events, such as a weight of a tote (shelf, bin, or other container) not matching a pre-calculated, expected weight of that tote. For example, the computer may expect a tote to weigh 15.2 lbs after a product is placed in the tote, but the tote may instead weigh 16 lbs. Additionally, the computer may identify an exception upon determining that the tote (shelf, bin, or other container) is prematurely full, based on what has already been placed in the tote, what remains to be picked and placed in a tote, and a current status of the tote. The computer may also identify an exception upon determining a pattern of exceptions associated with a particular product being picked. For example, the computer may recognize that upon picking a particular product, an exception (such as the tote being too full) may occur.

The computer may determine whether the exception is a result of an incorrect product dimension by accruing suspicion of a product's unanticipated dimension (e.g., suspicion that the product dimension mismatches a documented product dimension) each time the product is involved in an exception. In the event the accrued suspicion satisfies one or more thresholds (or exceeds a tolerance), the computer may trigger an action (e.g., inspect the product, measure the product, weigh the product).

I. Components and Operations of Illustrative Systems

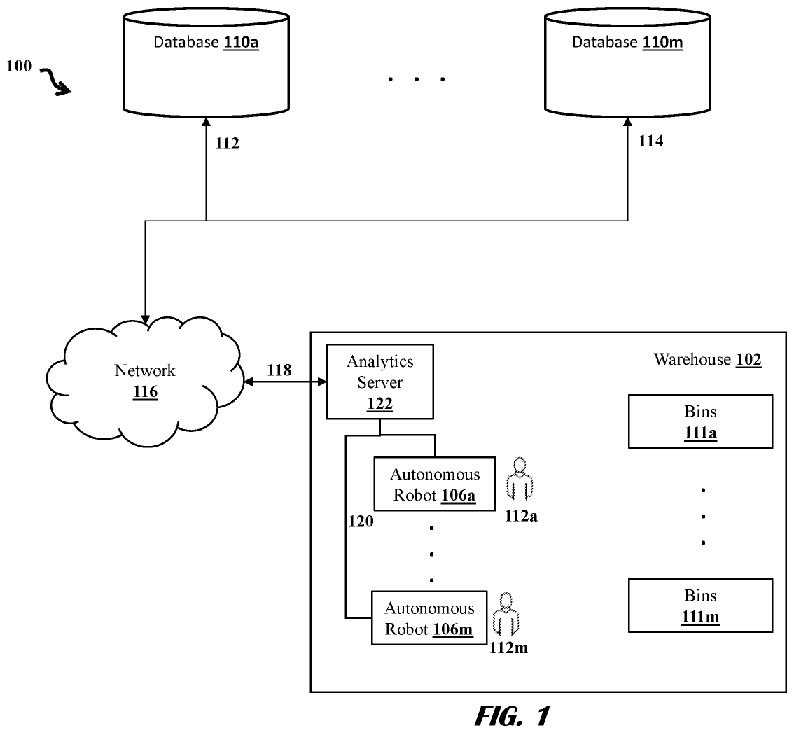

FIG. 1 illustrates a system 100 for adaptively updating and correcting product dimension, according to an embodiment. The system 100 includes a number of databases 110a to 110m (collectively referred to as database(s) 110) connected to a communications network 116. The communications network 116 connects to an analytics server 122 associated with a warehouse 102. The warehouse 102 may contain autonomous robots 106a to 106m (collectively referred to as autonomous robot(s) 106), workers 112a to 112m (collectively referred to as worker(s) 112), and shelves/racks/bins 111a to 111m (collectively referred to as bin(s) 111). Embodiments may include or otherwise implement any number of devices capable of performing the various features and tasks described herein. For example, FIG. 1 shows the analytics server 122 as a distinct computing device in the warehouse 102. In some embodiments, the analytics server 122 may be located in a different warehouse or capable of communicating with analytics servers 122 in various warehouses. Embodiments may comprise additional or alternative components, or may omit certain components, and still fall within the scope of this disclosure.

The databases 110 store and manage data records of various products. For instance, a manufacturer database may store product dimensions (including size and weight). The manufacturer database may store both current dimensions and previous dimensions of the product and/or the product's container. Additionally or alternatively, a retail database may store records of shipping package weights and associated costs. For example, the retail database may store shipping information related to an order of 40 shampoo bottles. The shipping information may include the retailer paying $30 to ship the order of 40 shampoo bottles to a retail store. Additionally or alternatively, the retail database may store information such as the size of the container that the shampoo bottles arrived in, the weight of the container, and the like.

The databases 110 are coupled via communications links 112, 114, respectively, via communications network 116 and via communications link 118 to the analytics server 122 associated with the warehouse 102. The communications network 116 may be a public or private network, and the communications links 112, 114, 118 that connect to communications network 116 may be wired or wirelessly. Non-limiting examples of the communications network may include: Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols.

The analytics server 122 is associated with warehouse 102 and may be physically located at the warehouse 102 or located remotely from warehouse 102. In the schematic embodiment shown in FIG. 1, the analytics server 122 is shown as being located in the warehouse 102, which may represent a physical and/or remote location of the analytics server 122 or its functionality, though the analytics server 122 may be located in a remote location. The analytics server 122 may be implemented as a distributed system or as a single device. In the case of a distributed system, one or more processors located outside the warehouse or in other devices may be, and sometimes are, used to perform one or more steps attributed to the analytics server 122 in this embodiment.

The analytics server 122 may calculate, determine, and identify exceptions (e.g., anomalies in warehouse operations). The analytics server 122 also communicates with databases 110, autonomous robots 106, and devices associated with workers 112 (e.g., mobile phones, personal data assistants (PDA), tablet computers, handheld scanners, or wearable devices). The communications may include retrieving, updating, and transmitting.

In an example, the analytic server 122 may collect warehouse operation data and identify warehouse exceptions resulting from changes in one or more product dimensions. The analytics server 122 may notify (e.g., via a notification message) one or more users (e.g., supervisors, workers 112, warehouse managers, databases 110) of a calculated suspicion score for each of the products involved in the exception, where the suspicion score represents a likelihood of a dimension change for each of the products. In some instances, the analytics server 122 notifies one or more users of the suspicion score in the event that the suspicion score exceeds a tolerance, such as a threshold. The analytics server 122 may cause the notification to display on the autonomous robot 106 or the worker's device. Additionally or alternatively, workers 112 may utilize a wearable device (e.g., earpiece, glasses, watch, wrist computer) configured to receive instructions and/or the notification from the analytics server 122. In other embodiments, the autonomous robots 106 receive instructions and/or notifications from the analytics server 122 and transmit the instructions and/or notification to the workers 112.

The analytics server 122 may monitor warehouse operations and recalculate the suspicion score for the dimensions of each of the products. The analytics server 122 may also trigger product dimension verification checks by instructing a device, such as an automated device (e.g., scales, imaging systems, autonomous robots 106), to inspect the product.

The analytics server 122 may store in a database exception information associated with each SKU in the warehouse 102. The analytics server 122 may also transmit exception information and/or transmit a notification of a suspicion score associated with the SKU exceeding the tolerance to databases 110 associated with the SKU.

II. Autonomous Robots

Workers may pick products from bins or shelves in a warehouse or other storage facility and load the picked products on an autonomous robot. Workers may also navigate through a warehouse or other storage facility with an autonomous robot, replenishing the bins or shelves in a warehouse with products stored on the autonomous robot. Workers may also bring an autonomous robot to one or more packing stations such that the products on an autonomous robot may be unloaded and packed for shipping.

The system can be configured for robotics to replace or assist the pickers. In some implementations, a robotic autonomous robot may move autonomously throughout the warehouse or storage facility. When moving autonomously, the autonomous robot can move alongside a picker or independently of a picker to locations in the warehouse. In other implementations, the robotic autonomous robot can pick products from bins or shelves and load the picked products onto the autonomous robot. The robotic autonomous robot may also place products from the autonomous robot onto bins or shelves.

As shown in FIG. 1, autonomous robots 106 are located in the warehouse 102 and controlled by the analytics server 122 via communications link 120. Workers 112 may work alongside the autonomous robots 106 to perform operations (e.g., pick products from bins 111 in the warehouse 102 and place those products in the autonomous robot 106, replenish bins 111 in the warehouse by stocking products on the bins using the products in an autonomous robot 106, and remove products from the autonomous robot 106 such that the products may be unloaded and packaged for shipping). In the example used herein, the autonomous robot is robotic and has autonomous operation based on instructions communicated from the analytics server 122. In some embodiments, the autonomous robot may be manually operated by a worker, who may push, pull, drive, or otherwise move the autonomous robot around the warehouse 102. For example, the autonomous robot may have a shopping cart configuration. A manually-operated autonomous robot may still use other components for communicating with the analytics server 122 and the worker 112, such as a screen for communicating information to the worker 112 from the analytics server 122.

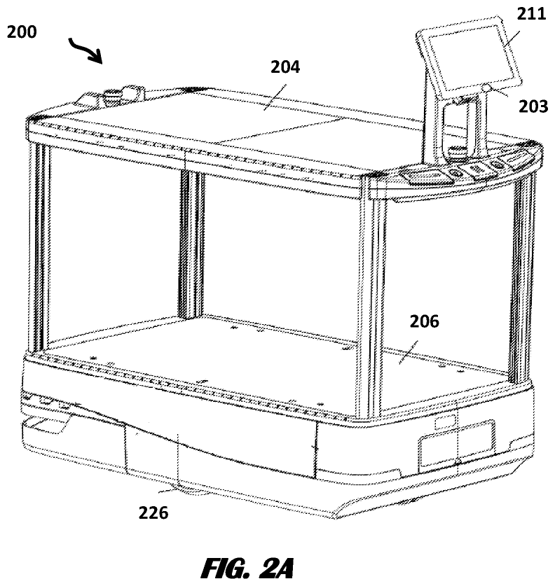

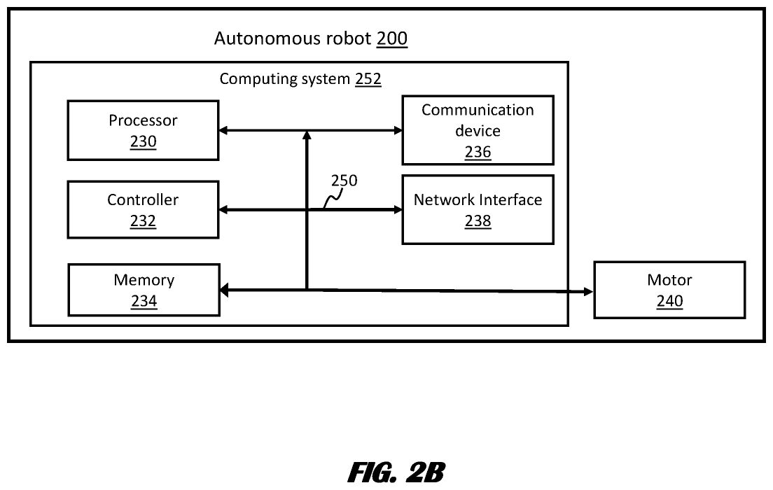

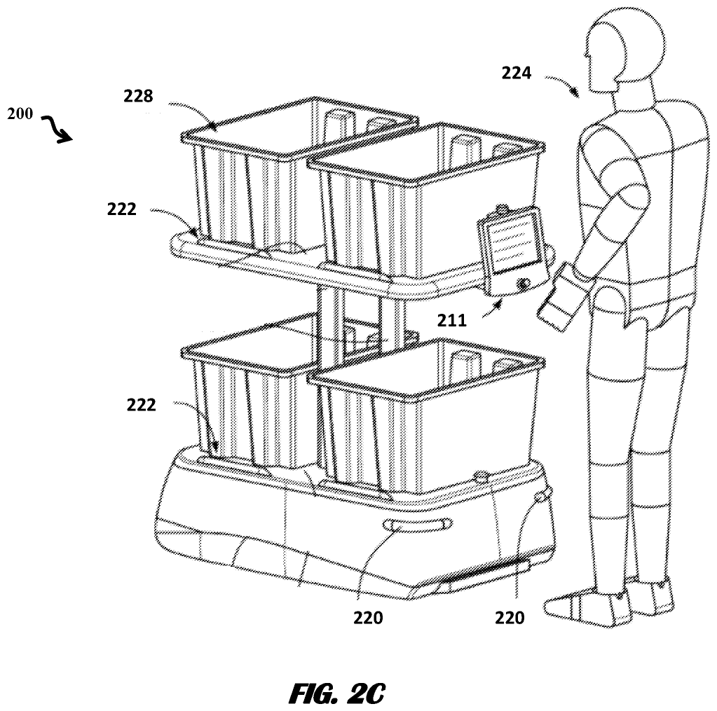

FIG. 2A shows an autonomous robot 200, according to an embodiment. The autonomous robot 200 has wheels 226, display 211, speaker 203 and two shelves 204, 206. In some instances, weighing scales (not shown) may be incorporated into the shelves 204, 206. For instance, the shelves may include pressure plates. The autonomous robot 200, through notifications displayed on display 211 and/or audio instructions provided via speaker 203, may notify a worker of the total weight of products on the shelves 204, 206 (e.g., the weight of the products on each shelf 204 and 206 respectively, the weight of combined shelves 204, 206). One or more totes (as described in FIG. 2C) can be, and sometimes are, transported on each of the shelves 204, 206 of the autonomous robot 200. The scales may have a tare feature such that the weight of totes on the scales can be zeroed. Eliminating the weight of the tote on the scale allows the analytics server to determine the weight of the products in the tote.

While a two-shelf autonomous robot embodiment is shown, multiple autonomous robot configurations are possible, with some autonomous robots being implemented using a single shelf while other autonomous robots have two or more shelves. Each of the totes on the autonomous robot may have several levels (layers, zones) for storing and transporting the picked products.

The autonomous robot 200 may be configured to determine product dimensions. For instance, a weighing autonomous robot may utilize shelves 204, 206 with scales to weigh the products. Additionally or alternatively, a measuring autonomous robot may carry one or more measuring devices (e.g., augmented reality measurement tools, rulers, measuring tape) and/or be configured with an imaging system such that the processor (230 in FIG. 2C) on the autonomous robot may determine the size of the product (e.g., depth, width, height). For example, the processor may perform object recognition to measure the product such that the imaging processing may recognize a product and even distinguish it from a hand of a worker. In some instances, the processor may support object recognition capabilities and/or be capable of executing the imaging system. The processor may determine the dimensions of the product and communicate the product dimensions to the analytics server (122 in FIG. 1). Additionally or alternatively, the analytics server may receive image data (raw data, compressed data) from the imaging system and perform object recognition to determine the dimensions of the products placed on the autonomous robot 200. The autonomous robot 200 may be configured for both weighing products and measuring the sizes of products.

The autonomous robot 200, through visual instructions displayed on display 211 and/or audio instructions provided via speaker 203, may transmit an instruction to place one or more products on an inspection station. For example, a picker assigned to an autonomous robot 200 may receive instructions displayed the autonomous robot 200 to pick a product to be inspected on route to a location (e.g., such as an inspection station, a subsequent product location, etc.) Additionally or alternatively, an administrator (using a management console, for instance), may trigger an inspection. A management console or other administrative device may transmit an instruction (via display 211, speaker 203, and/or wearable devices worn by the picker) to place one or more products on an inspection station, place one or more products on an autonomous robot 200 on route to a location, and the like.

The autonomous robot 200 may also act as the inspection station. Inspection stations may also include designated areas of the warehouse in which a product is weighed and/or measured. Additionally or alternatively, the autonomous robot 200, through visual instructions displayed on display 211 and/or audio instructions provided via speaker 203, may transmit an instruction to measure one or more products using equipment in the warehouse (e.g., measuring tape, rulers, or scales).

FIG. 2B shows a block diagram 260 of an autonomous robot 200 for use in warehouse operations, according to an embodiment. The computing system 252 of an autonomous robot 200 may include a processor 230, a controller 232, a memory 234, a communication device 236, and a network interface 238. The autonomous robot 200 may also include a motor 240. Each of the components 230, 232, 234, 236, 238, 240 may be interconnected, for example, using a system bus 250. Although the components of computing system 252 are shown as integrated in the autonomous robot 200, one or more of these components can be housing in a separate computing device or system. Further, although one of each component of the computing system 252 and one motor 240 is shown in FIG. 2B, it is intended that the autonomous robot 200 can be configured with one or more of each of these components.

The computing system 252 may receive and/or obtain information about a customer order (e.g., from the analytics server), including a list of products, the dimensions of the products, the weight of the products, characteristics of the products (e.g., a fragility score, a hazard score), the priority of the order relative to other orders, the target shipping date, and whether the order can be shipped incomplete (without all of the ordered items) and/or in multiple shipments, etc.

The controller 234 may send control signals to the motor 240 and/or other components of the autonomous robot 200 as described further herein. The motor 240 may convert electrical energy received from an electrical power source (e.g., battery, supercapacitor, etc.) into rotations of the wheels (226 in FIG. 2B). The motor 240 propels the autonomous robot 200 such that the autonomous robot 200 moved autonomously and does not require a push or pull by a human or other force for movement.

The memory 234 stores information within the computing system 252. In some implementations, the memory 234 is a non-transitory computer-readable medium that stores instructs for execution by the processor 230. The memory 234 may be a volatile memory unit or a non-volatile memory unit.

The memory 234 may store warehouse operation information. The warehouse operation information may include documented product dimensions, tote capacity (e.g., weight limit, product count limit), shelf capacity (e.g., weight limit, product count limit), and bin capacity (e.g., weight limit, product count limit). The memory 234 may also store product information such as a product name, a product description, a product image, a number of anomalies associated with each product, the date of the last anomaly associated with each product, and a suspicion score representing a probability of the suspect product's dimension changing. The memory 234 may also store error information such as errors associated with the picker assigned to the autonomous robot 200, errors associated with that warehouse, and the like. The memory 234 may also store product dimension verification instructions (e.g., how to measure the weight of the product; how to measure the height, width, and depth of the product; how to place the product such that one or more imaging systems may measure the height, width, and depth of the product; instructions regarding the operation of one or more imaging systems such that the imaging system may measure one or more product dimensions; instructions regarding the operation of one or more scale systems such that the scale system may measure the product weight).

The processor 230 is capable of processing instructions for execution within the computing system 252. At least a portion of the functionality described herein may be realized by instructions that upon execution cause the processor 230 to carry out the processes and functions described herein. Such instructions may include, for example, interpreted instructions such as script instructions, or executable code, or other instructions stored in a non-transitory computer readable medium.

In some implementations, the processor 230 may be a single-threaded processor or a multi-threaded processor. The processor 230 may perform tasks associated with the autonomous robot 200. For example, an autonomous robot 200 may include one or more scales, sensors, augmented reality measurement tools, rules, measuring tape and the like to measure the dimensions of product. The autonomous robot 200 may utilize processor 230 to take, receive, derive, infer, predict, and calculate measurements associated with one or more products. An autonomous robot 200 may include one or more cameras, lasers, light curtains, barcode scanners, or other optical sensors to image products. The autonomous robot 200 may utilize processor 230 to perform object recognition, object tracking, computer vision, and the like.

The processor 230 in the autonomous robot 200 (and/or the analytics server 122 in FIG. 1) controls the autonomous robot's 200 movement to/from one location (e.g., pick location) to the next location (e.g., unloading station, subsequent pick location). The processor 230 may be in communication with controller 232 and/or motor 240. In the event the autonomous robot 200 becomes associated with a different worker (e.g., a worker at an unloading station or a second picker taking over picking for the first picker), the autonomous robot 200 may require the second worker to log in to the autonomous robot 200 (e.g., via the touch screen 211 in FIG. 2A) prior to the autonomous robot 200 providing guidance as to the next operation performed by the second worker.

The network interface 238 may be configured to receive and transmit messages and/or instructions. The network interface 238 may be a wireless network interface capable of receiving commands and information from the analytics server and sending information (e.g., warehouse operation anomaly information) to the analytics server via wireless signals.

The network interface 238 may be configured to process signals from the analytics server and/or other autonomous robots in the warehouse. The network interface 238 may be, for instance, an Ethernet card, a serial communication device, e.g., an RS-232 port, and/or a wireless interface device, e.g., an 802.11 card, a 3G wireless modem, or a 4G wireless modem.

FIG. 2C shows the autonomous robot 200 carrying a plurality of totes 228, according to an embodiment. Although FIG. 2C illustrates the autonomous robot 200 having four totes 228, it is intended that the autonomous robot 200 may be configured for one or more totes 228 and in various shelving and stacking arrangements. The autonomous robot 200 may display on screen 211 instructions for a worker 224. The instructions may instruct the worker 224 to place products in the totes 228 or remove products from the totes 228 (e.g., unload at a particular bin/shelf). The worker 224 may place (or remove) the product in a particular tote 228 based on lights 222, 220 indicating the particular tote. That is, the lights 222, 220 may illuminate, directing the worker 224 to place (or remove) the product in the indicated tote 228. Additionally or alternatively, the display 211 may display instructions instructing the worker 224 which tote 228 to place (or remove) the products.

Additionally or alternatively, one or more imaging systems (e.g., scanners) may operate in conjunction with (or replace) lights 220, 222. The imaging system may be used to measure the dimensions of products as the products enter the tote. For example, object recognition may be performed to recognize a product and even distinguish it from a hand of a worker 224. As discussed herein, the processor (230 in FIG. 2B) may support object recognition capabilities and/or be capable of executing the imaging system. Additionally or alternatively, the analytics server (122 in FIG. 1) may receive image data (raw data, compressed data) from the imaging system and perform object recognition to determine the dimensions of the products entering the totes 228.

The display 211 and/or speaker may instruct the worker 224 to place the product directly on the autonomous robot 200. In such a scenario, the worker 224 may not load or operate the autonomous robot 200 with four totes 228. Rather, the worker 224 may load the autonomous robot 200 with two totes 228, for instance, and reserve space on the autonomous robot 200 for large or bulky products.

III. Illustrative Methods of Operation

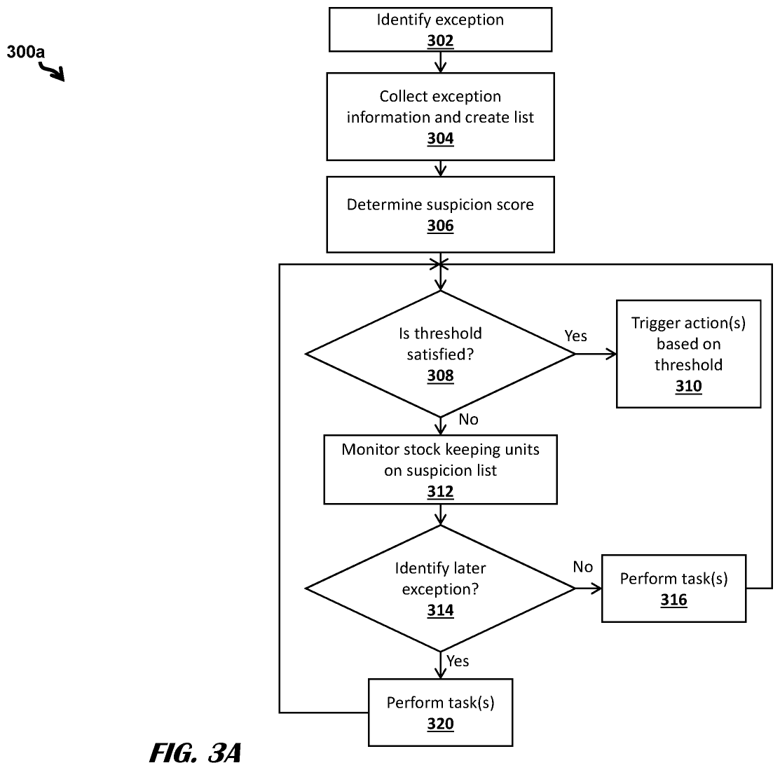

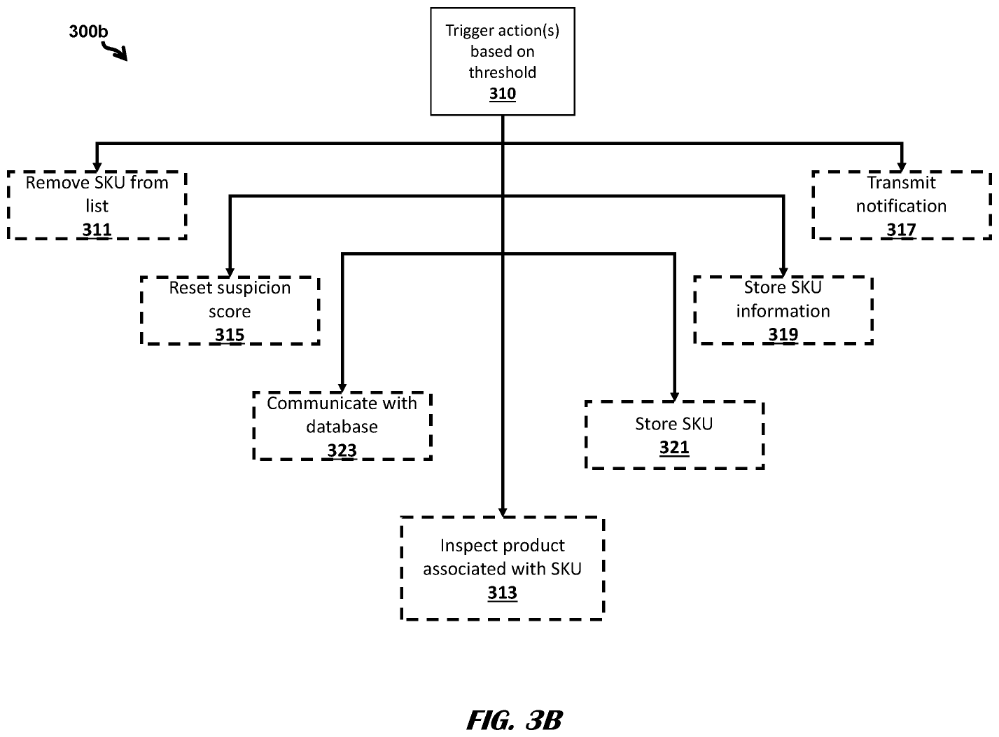

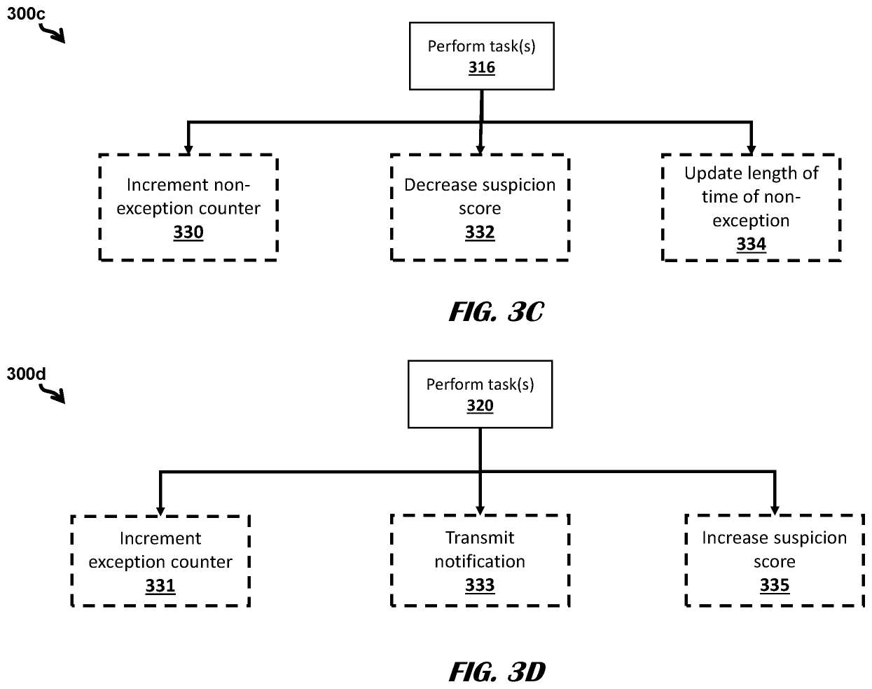

FIG. 3A shows steps of executing a method 300a for identifying exceptions during warehouse operations and determining a suspicion score associated with the products involved in the exception, according to an embodiment. The suspicion score may indicate the probability of a particular product of the set of products causing the exception. A high suspicion score indicates that the particular product likely caused the exception because the dimensions of the product may have changed. The method may be implemented by an analytics server (or other computing device) associated with the warehouse and executes machine-readable software code for exception detection and product dimension verification/correction. Some embodiments may include additional, fewer, or different operations than those described in the method 300a and shown in FIG. 3A. The various operations of the method 300a may be performed by one or more processors executing on any number of computing devices.

In step 302, the analytics server may identify an exception. Additionally or alternatively, the analytics server receives an input or transmission from another device, such as a device of a worker using wearable technology (or a mobile device, a tablet, and/or the display on an autonomous robot) indicating that an exception has occurred.

The exception may occur at various stages of the warehouse operation. For example, the analytics server may identify an exception related to a tote (or shipping package) where the tote is unable to hold the product (e.g., the tote has exceeded the product capacity). For instance, the analytics server may use a laser (or a light curtain) to define a plane associated with the tote (e.g., above the tote, at the edge of the tote, etc.). The laser may be located on the tote and/or on the autonomous robot. The analytics serer may use the plane to determine that a portion of the product exceeds the bounds of the plane, indicating that the tote is unable to hold the product. As a result, the analytics server may determine that the product does not fit in the tote. Additionally or alternatively, the analytics server may use an imaging system to determine that the tote has exceeded the product capacity. In the event an exception is detected, it may be unclear as to which product resulted in the exception because the last product placed into the tote may not have been the product that caused the exception. For instance, the second product placed into the tote may have changed dimension, thereby minimizing the remaining available space in the tote more than expected in advance of when the other products were placed inside of the tote.

A worker may identify an exception related to a shelf/bin/tote where the shelf/bin/tote is unable to hold the product (e.g., the product does not fit on the shelf/bin and the worker is unable to place the product) That is, the worker may identify that the shelf/bin/tote is too full. The analytics server may receive input from the worker indicating the capacity of the shelf/bin/tote.

Additionally or alternatively, the analytics server may identify an exception related to a shelf/bin where the shelf/bin is unable to hold the product. For instance, the analytics server may determine that the tote and/or autonomous robot that was used to carry the products to the shelves/bins is not empty of all of the products that were supposed to be placed on the shelf/bin (e.g., the weight of the tote/autonomous robot may not be a predetermined weight). For example, a tote may contain 40 products and weigh 40 lbs. The analytics server may instruct a worker to place five products on a particular shelf to replenish the inventory of that shelf. The worker may miscount the number of products placed on the shelf, believing that five products have been placed on the shelf when only three products have been placed on the shelf. The worker may believe that five products have been placed on the shelf because of human error (the shelf appears full, the worker got distracted while placing the products, etc.).

The analytics server may have historic information related to the weight of the products being placed on the shelf. For example, the analytics server may have stored in memory that the product being placed on the shelf weighs 1 lb. The analytics server may determine, using the historic weight of the product and the current weight of the tote, that the weight of the tote after the five products are placed on the shelf should be 35 lbs. If the worker indicates that the worker has placed the products on the shelf, but the analytics server determines that the tote weighs 37 lbs instead of 35 lbs, the analytics server may determine that an exception has occurred.

In the event an exception is detected, it may be unclear whether the shelves/bins were properly replenished, which product resulted in the exception on the shelf/bin, whether there was an error in placing the products on the shelf/bin, and the like. For example, while detecting that an exception has occurred, the analytics server may be unable to determine whether there was human error (e.g., the worker miscounted the products placed on the shelf) or whether a separate or additional exception has occurred.

The exception may be a result of multiple product dimensions changing (e.g., change in both size and weight, change in both length and width). The exception may be a result of human error. For example, a worker may have placed one or more excess units of the product in the tote, creating a situation in which the analytics server would detect an exception. Similarly, the worker may have placed the product in the tote inefficiently such that other products that were supposed to fit in the tote are unable to fit in the tote. Additionally or alternatively, the worker may have falsely identified an exception.

The analytics server may generate a notification to verify that the exception is not the result of an error or accident. For instance, in the event that 25 products are expected to fit on a shelf, the analytics server may generate a notification to confirm a count of the products on the shelf and confirm whether 25 products fit on the shelf. This notification may be sent to the worker associated with the exception and/or a supervisor.

As described herein, a product has its own stock keeping unit (SKU). Multiple units (items, eaches) of the product would all have the same SKU. For example, if there are ten of the same type of shampoo bottle, the type of shampoo bottle is the product, and there are ten items of that shampoo bottle. The shampoo bottle product would have one SKU.

The analytics server may determine that a single SKU was involved in the exception. For instance, there may be an exception involving an order for 100 shampoo bottles. In response to determining that the single SKU is involved both in the order and the exception, and assuming a good tare (e.g., for the tote or the packaging) the analytics server may immediately confirm (e.g., without proceeding through steps 304-320) whether the dimensions of the product have changed. The analytics server may instruct a device and/or worker to weigh or measure the product and compare the inspected product to stored dimensions of the product. In the case of multiple SKUs involved in an exception, it may be unclear which product in the order may have caused the exception. However in the case of only one SKU involved in the exception, the analytics server may immediately determine whether the product dimensions have changed.

In step 304, in response to identifying the exception, the analytics server may collect information associated with the exception. The type of exception may be indicative of the type of product dimension change (e.g., whether the weight of the product changed, the size of the product changed, or both). For instance, certain exceptions may be indicative of a product size (e.g., length, height, depth) changing. Non-limiting examples of exception types indicative of the product size changing include: a tote being overfull or having unexpected extra capacity during a picking process, a shipping container being overfull or having unexpected extra capacity during a packing process, a shelf/bin being overfull or having unexpected extra capacity during a picking and/or replenishment process, and a shipping container size deviating from a predetermined shipping container size.

Additionally or alternatively, certain exceptions may be indicative of a product weight changing. Non-limiting examples of exception types indicative of the product weight changing include: a shipping cost deviating from a predetermined cost (e.g., a prior cost, a calculated cost, a cost retrieved from one or more databases), an aggregate shipping cost across more than one shipment deviating from a predetermined cost for the aggregate shipping, a shipping weight deviating from a predetermined shipping weight (e.g., a prior weight, a calculated weight, a weight retrieved from one or more databases), an aggregating shipping weight across more than one shipment deviating from a predetermined aggregate shipping weight, a tote weight deviating from a predetermined tote weight (e.g., a prior weight, a calculated weight, a weight retrieved from one or more databases), and a shelf/bin weight deviating from a predetermined shelf/bin weight (e.g., a prior weight, a calculated weight, a weight retrieved from one or more databases).

The analytics server collects information associated with the exception including the exception type, the SKUs involved in the exception, the date/time of the exception, the worker performing the warehouse operation resulting in the exception or otherwise associated with the exception, and the like.

The analytics server may populate a dynamic list in a database (e.g., database of the analytics server, database in a warehouse, database remote from analytics server and/or warehouse) of each of the SKUs involved in exceptions in the warehouse. In one configuration, the list may include a data record for each SKU. In another configuration, the list may only include a data record for each SKU that has a suspicion score above 0.0 (or other threshold). Put another way, in such a configuration, the list may only include data records for SKUs having suspicion scores that exceed a defined threshold. For each data record, the list may include information associated with the exceptions, and the information may include each exception, aggregated data regarding all exceptions within a timeframe, and/or the latest one or more exceptions. For example, the list includes a data record for a SKU associated with the shampoo bottle, and the data record includes information including the date of the exception, the time of the exception, the exception type, the extent of the exception (e.g., a difference between a standard warehouse operation and the exception), a suspicion score for the latest exception, a suspicion score for all exceptions within a timeframe, a suspicion score for the latest exceptions, and the like. Each data record may also include information involving a particular threshold that should be used for that SKU, if applicable, as described herein.

In response to identifying an exception, the analytics server may update the list to include any SKUs involved in exceptions. The analytics server may also update a suspicion score associated with each SKU (as discussed in step 306). If a SKU is already on the list, the analytics server may update the data record to include a new suspicion score associated with the SKU. The suspicion score may indicate a probability associated with the dimensions of the product changing. For instance, the suspicion score may be a probability that one or more dimensions of the product associated with the SKU have changed. Updating the suspicion score may include updating the field from 0.0 to a particular score to show a probability. In one alternative, updating the suspicion score may include populating the field of the data record with the newest suspicion score. In another alternative, updating the suspicion score may include recalculating an aggregated suspicion score to account for a previous suspicion score as well as the newest suspicion score.

The analytics server may utilize statistical methods to remove noise (e.g., using a Kalman filter) from a signal and utilize only statistically significant data. For example, the analytics server may utilize a Z-test or a T-test, depending on the available historic exception data associated with a particular product. The analytics server may also utilize a machine learning model (such as a neural network, support vector machine, logistic regression, decision trees, clustering, etc.) to make adjustments to particular measurements (e.g., weight at a scale) for any workflow-triggering thresholds. If the analytics server determines that the exception is not statistically significant, the analytics server may determine that the exception may be an error or a coincidence. The analytics server may not proceed through steps 306-320. If the analytics server determines that the exception is statistically significant, the analytics server may proceed through steps 306-320.

In step 306, the analytics server may determine the suspicion score for each SKU involved in the exception. The suspicion score may be the probability of that SKU causing the exception (e.g., the probability that product dimensions have been changed, a suspicion probability). In an example, the analytics server may determine the probability of the SKU causing the exception to be 1/x, where x is the number of SKUs involved in the exception. For example, a worker may fill a tote with twenty products: ten shampoo bottles and ten conditioners bottles. The probability of each SKU (shampoo, conditioner) causing the exception would be ½ (i.e. 50%) because there are two unique products with associated SKUs (the SKU for the shampoo bottle and the SKU for the conditioner bottle). Additionally or alternatively, the analytics server may determine the suspicion score using a predetermined suspicion score for each of the SKUs involved in the exception. For instance, a shampoo product involved in an exception may have a predetermined 10% probability (e.g., there is a 10% probability that one or more dimensions of the shampoo bottle have changed). Additionally or alternatively, a hazardous, perishable, or fragile product involved in an exception may have a 60% probability (e.g., there is a 60% probability that one or more dimensions of the hazardous product have changed).

In decision 308, the analytics server determines whether one or more thresholds have been satisfied. The analytics server may evaluate whether the suspicion score has satisfied a threshold, whether the number of exceptions (or non-exceptions) has satisfied the threshold, whether a duration of time has satisfied the threshold, and the like. In some configurations, the analytics server may employ a machine learning model (such as a neural network, support vector machine, logistic regression, decision trees, clustering, etc.) to predict and/or classify whether the suspicion score has satisfied a threshold. As described herein, the analytics server may adjust the threshold after determining the statistical significance of the underlying measurements.

The analytics server may apply the same threshold for all products or varied thresholds. For example, the analytics server may determine per product thresholds. For instance, a hazardous product (or fragile product, perishable product) may have a lower threshold than a non-hazardous product (or non-fragile product, non-perishable product).

In an illustrative example, a vendor may have changed the dimensions of a milk carton. Upon receiving a shipment of milk cartons from the vendor, the analytics server may instruct a worker to replenish the milk cartons in the warehouse by placing 30 milk cartons on a refrigerated shelf. The new dimensions of the milk carton may prohibit the worker from placing 30 milk cartons on the refrigerated shelf. For instance, only 28 cartons may fit on the refrigerated shelf, instead of the 30 cartons that could have previously fit on the shelf. In response to the exception, the analytics server assigns a suspicion score for the milk carton. As a perishable product, the analytics server may determine that the score exceeds a lower threshold such that an action (e.g., step 310) is more likely to be triggered.

Additionally or alternatively, there may be a threshold specifically for milk cartons that is lower than other products. In response to identifying the same exception in another instance, the analytics server may trigger an action (e.g., step 310) for the milk cartons as opposed to other products involved in the exception because the threshold for triggering an action is lower for milk cartons.

The advantage of manipulating the threshold for the milk carton (or manipulating the suspicion score associated with milk cartons) may be to prevent the milk from spoiling. For instance, instead of monitoring the SKU to determine whether the SKU is involved in various other warehouse operations (e.g., step 312), the perishable product may be inspected immediately (e.g., a possible action in step 310). The inspection may result in a finding that the milk carton dimensions have changed, and the milk may need to be stored in a new (or additional) location in the warehouse. The freshness of the milk is dependent on the timeliness of the finding that the milk carton dimensions have changed. Therefore, it may be advantageous for the analytics server to associate particular scores and/or thresholds with various products.

The analytics server may also utilize lower thresholds for extreme dimension and/or unusual dimension products. As a result, instead of monitoring the SKU of the product with an extreme dimension and/or unusual dimension as the SKU is involved in various other warehouse operations (e.g., step 312), the product with the extreme dimension and/or unusual dimension may be inspected immediately (e.g., a possible action in step 310). Dimension changes associated with products with extreme dimensions and/or unusual dimensions may more immediately impact warehouse storage management. For example, workers may place products with extreme dimensions and/or unusual dimensions in particular areas in the warehouse. For instance, 100 lbs of cement may have a unique storage location in the warehouse. In the event the particular vendor stops shipping the 100 lbs of cement and instead ships 150 lbs of cement, the location that previously stored the 100 lbs of cement may not be capable of storing 150 lbs of cement. The re-arranging of the bags of cement may require additional resources (e.g., equipment and time) that reduces the efficiency of the warehouse operations.

Additionally or alternatively, the analytics server may determine per warehouse thresholds. In an example, the analytics server may customize thresholds with respect to particular warehouses. In an illustrative example, a warehouse may utilize customized thresholds based on a number of workers in the warehouse. For example, a warehouse with ample workers may use lower thresholds such that the available workers may inspect products as exceptions are identified (e.g., at a first exception). Warehouses with more workers may have the capability to investigate product dimensions. In contrast, warehouses that do not have excess workers may use higher thresholds such that the workers inspect products when exceptions are numerous.

Additionally or alternatively, the analytics server may determine per product history thresholds. In an example, the analytics server may adaptively generate thresholds based on the frequency of product dimensions changing (e.g., seasonal vegetable baskets) and/or the frequency of errors in the dimension of a particular product. For example, some products may be more difficult to accurately measure. In these instances, it may be advantageous to have a higher threshold to trigger an action (e.g., step 310) because based on the product history, it may be common and/or predictable that a particular product's dimension may change.

Additionally or alternatively, the analytics server may utilize various thresholds. For example, different thresholds may correspond to varying levels of a likelihood of a dimension change. For instance, in the event a suspicion score exceeds a “grey” threshold, the analytics server may determine that there is a low likelihood associated with that product dimension changing. In the event the suspicion score exceeds a “red” threshold, the analytics server may determine there is a high likelihood associated with that product dimension changing. The analytics server may transmit a notification of the products at various threshold levels to one or more devices (e.g., a supervisor's device). For instance, a supervisor may review the SKUs that have exceeded a “red” threshold to evaluate whether the SKU needs to be inspected.

Additionally or alternatively, the analytics server may determine a threshold for a number of exceptions detected. For example, the analytics server may determine that a SKU involved with four exceptions should be inspected (e.g., a possible action in step 310). In the event the SKU is associated with five exceptions (e.g., based on the analytics server monitoring the SKU as discussed in step 312), the analytics server may determine that the number of exceptions detected for that particular SKU exceeds the threshold number of exceptions. Similarly, the analytics server may adaptively determine a threshold number of non-exceptions. For instance, a user may determine that a SKU involved in four warehouse operations that do not result in exceptions may be taken off of the list (e.g., a possible action in step 310). In the event the SKU is associated with four warehouse operations that have not resulted in exceptions, the analytics server may remove the product from the list.

The analytics server may also determine a threshold amount of time for non-exceptions. For instance, the analytics server may determine that if three months have passed without any other identified exception associated with a particular SKU (e.g., the SKU being monitored), the SKU may be removed from the list. This threshold based on the amount of time may require that the SKU be present in at least one task or a container where there was no exception. Otherwise, the analytics server may not have identified an exception for that SKU because that SKU was not involved in a warehouse operation (e.g., picking, stocking).

In step 308, the analytics server may also evaluate a combination of thresholds in determining whether the SKU should be monitored (e.g., proceed to step 312) or an action should be triggered (proceed to step 310). Examples of combinations of thresholds may include a ratio of exceptions detected to non-exceptions detected, a suspicion score being above a threshold and above a number of detected exceptions being above a threshold, and the like.

In the event the one or more thresholds have not been satisfied, the analytics server may proceed to step 312. In the event the one or more thresholds have been satisfied, the analytics server may trigger an action, as shown in step 310.

In step 310, the analytics server may trigger one or more actions. FIG. 3B shows an example 300b of optional actions that may be triggered, according to an embodiment. The triggered actions may depend on the threshold that has been satisfied. For example, as shown in step 311, a SKU (that may have been monitored according to step 312) may be removed from the list given that the certain thresholds as discussed herein have been satisfied. For instance, the analytics server may remove a SKU from the list based on a determination that the SKU has been involved in a number of non-exceptions satisfying (or exceeding) the threshold number of non-exceptions, e.g., there have been a threshold number of warehouse operations involving the SKU that have not resulted in exceptions. Additionally or alternatively, there may be a threshold of a low suspicion score such that when the threshold is exceeded, the analytics server may determine that the dimensions of the product associated with the low suspicion score have not changed. The analytics server may update the list and remove the SKU associated with the low suspicion score. In response to exceeding the low suspicion score threshold, the analytics server may generate and transmit a notification to one or more users, notifying the users of the SKU exceeding the low suspicion score threshold and being removed from the list.

As shown in step 313, the analytics server may initiate an inspection of a product associated with a SKU (that may have been monitored according to step 312) given that certain thresholds as discussed herein have been satisfied. For instance, in the event of a threshold suspicion score, a SKU with a suspicion score exceeding the threshold suspicion score may trigger an action related to inspecting the SKU. The analytics server may initiate the inspection automatically (e.g., by sending a command to an imaging system, camera, sensor, laser, scale) and/or manually (e.g., instructing a worker to inspect the product using a measuring tape, scale).

For example, the analytics server may instruct a measurement machine, such as a weight device (e.g., scale) or a dimension device (e.g., imaging system), to measure an identified product. In another example, the analytics server may generate and transmit instructions to the device that conducts an initial inspection of the product at the warehouse. In some instances, each time the warehouse receives a product for a first time, in addition to storing information related to that product, the analytics server may instruct the initial inspection device to measure the dimensions of the product. The analytics server may instruct the device that was used to perform the initial inspection of the product to re-measure the identified product.

Additionally or alternatively, the analytics server may transmit instructions to an autonomous robot to inspect (e.g., scan) the identified product. For instance, the autonomous robot may be configured with an imaging system and/or scale to measure the product. Additionally or alternatively, the analytics server may transmit instructions to an augmented reality device (e.g., headset, tablet, mobile phone, PDA) worn by a worker to capture measurements of the identified product. The instructions transmitted to the augmented reality device may include instructions that indicate how the product is to be measured such that products are measured in the same manner across the warehouse.

In some instances, product inspection is performed by designated devices or workers. The designated workers may inspect the products on the suspicion list starting with products associated with the most suspicious SKUs (e.g., have a high suspicion score) to the products associated with the least suspicious SKUs (e.g., have a low suspicion score). The workers may inspect products for the duration of their shift.

The analytics server may initiate an instruction to inspect the product in various ways (e.g., command to an automated device such as an autonomous robot with a robotic arm). The analytics server may schedule an inspection of the product with the associated SKU on the list in a minimally disruptive way. The analytics server may consider various factors in determining how to schedule the inspection of the product. First, the analytics server may consider minimizing the distance to the product associated with the SKU (e.g., selecting a task that is already routed towards picking the SKU, restocking the SKU, and the like). Second, the analytics server may consider urgency of inspecting the product associated with the SKU (e.g., selecting which SKUs are prioritized for inspection based on the urgency of inspecting that SKU). For instance, the analytics server may prioritize inspecting perishable products (or hazardous products and/or fragile products). In some instances, the analytics server may insert a new task to inspect the product rather than waiting for a pick/replenishment task to naturally arise. Third, the analytics server may consider autonomous robot capabilities (e.g., some autonomous robots may not be equipped with imaging systems). Fourth, the analytics server may consider worker capabilities (e.g., only a subset of workers may be proficient in product inspection tools). Notably, the analytics server may consider some or all of these or other factors in determining the scheduling of an inspection of a given product.

In an example, the analytics server may select an upcoming pick task involving a SKU with a suspicion score exceeding the threshold suspicion score and increment the pick quality of the SKU by one. For instance, in the event the analytics server determines that a shampoo bottle should be inspected (e.g., suspicion score of the SKU exceeds the threshold), and a picker is set to pick 30 shampoo bottles, the analytics server may instruct the picker to pick 31 shampoo bottles and bring the bottles to one or more designated areas in the warehouse (e.g., an inspection station that is on the way to a packing station). The analytics server may also interleave picking tasks (or other tasks) with the picker's task of bringing the shampoo bottle to one or more designated areas in the warehouse. The analytics server may add a designated area in the warehouse along the picker's pick route such that the autonomous robot can route the extra shampoo bottle to the designated area. Additionally or alternatively, the analytics server may instruct the picker to inspect one unit of the SKU at the designated area in the warehouse and/or to leave the unit at the designated area for inspection later by another worker.

In another example, the analytics server may select a putaway task (replenishing inventory in the warehouse, restocking) involving the SKU with a suspicion score exceeding the threshold and decrement the replenishment quality by one. For instance, in the event the analytics server determines that a shampoo bottle should be inspected (e.g., suspicion score of the SKU exceeds the threshold), and the worker is replenishing shampoo bottles (e.g., bringing shampoo bottles to their designated bin/shelf in the warehouse), the analytics server may instruct the picker to stock 29 shampoo bottles and hold one bottle for inspection. The analytics server may add a designated area in the warehouse along the putaway task route such that the worker can drop off the extra shampoo bottle. Additionally or alternatively, the analytics server may instruct the worker to inspect one unit of the SKU at the designated area in the warehouse.

In another example, the analytics server may select a packout task (e.g., pack one or more items for shipping) involving the SKU with a suspicion score exceeding the threshold to obtain a shipping weight measurement. For example, the analytics server may add an instruction to a worker performing a packout task such that the worker brings the product associated with the SKU in the packout task to an inspection station before the worker completes the packaging. The analytics server may add an inspection station as a destination to a worker's packout task route.

Additionally or alternatively, the analytics server may instruct one or more devices and/or workers to meet a worker at the worker's picking location (or a particular shelf/bin where the worker is performing a putaway task, or a packing station where a worker is performing a packout task). For example, the analytics server may activate a device and navigate the device (containing inspection equipment such as scales and sensors) to a location of the worker. Additionally or alternatively, various areas of the warehouse (e.g., the packing station, the inspection station) may be configured with measurement devices such that the analytics server may instruct a worker/device to inspect the product where the exception was identified.

In yet another example, the analytics server may instruct an automated autonomous robot (or a worker) to bring one unit of the SKU to an inspection station. The inspection station may be a designated area in the warehouse where products are inspected. The inspection station may have scales such that the analytics server may record an accurate product weight. The inspection system may also utilize imaging systems and/or cameras and/or lasers such that the analytics server may record an accurate product size (e.g., length, width, depth).

In another example, the analytics server may transmit an instruction (e.g., to a worker who is closest to one unit of the SKU, a worker who is not determined to be busy) to measure the dimensions of the product associated with the SKU. Additionally or alternatively, the analytics server may instruct a device (e.g., sensors located on the autonomous robot, in the totes, in the bins, on packout stations, on shelves, cameras) to measure the dimensions of the product associated with the SKU. In some instances, a worker (or automated device such as a robotic arm) may place a product of the SKU in a particular place for a particular period of time for proper measurement.

In some instances, the analytics server may schedule an inspection for each SKU on the list. That is, SKUs may be scheduled for inspection because the SKU was involved in an exception and placed on the list, and in response to exceeding a threshold. For example, the analytics server may still schedule SKUs that are removed from the list based on a low likelihood that the dimensions of the product associated with the SKU have changed. However, the analytics server may schedule the SKU that has been removed from the list during a time that likely won't interfere with warehouse operations (e.g., when the warehouse is being remodeled, when the warehouse is closed).

The analytics server may trigger one or more actions in step 310, as shown in FIG. 3B. For example, after removing the SKU from the list (step 311), the SKU's suspicion score may be reset (step 315). Additionally or alternatively, the analytics server may transmit a notification (step 317) of a SKU with a suspicion score exceeding the threshold to one or more users before the product associated with the SKU is inspected (step 313). In some instances, the analytics server may periodically transmit list information to the one or more users such that the one or more users may evaluate whether the SKU should be inspected (or removed from the suspicion list). Additionally or alternatively, the analytics server may instruct a worker/device to inspect the SKU associated with the product (step 313) by bringing the product to an inspection station and subsequently instruct the worker/device to return the product back to the SKU's storage location (step 321). The analytics server may also communicate with a database (e.g., query a database for product dimensions such as vendor database 110 in FIG. 1) (step 323). The analytics server may compare the inspected product dimensions to the received product dimensions and determine whether the product dimensions have changed.

The analytics server may also store SKU information (step 319). In some instances, the analytics server may initiate an inspection of a product, revealing that the product dimensions have not been changed. In response, the analytics server may store the date that the product was inspected, the suspicion score, and/or the exception(s) resulting in the inspection instruction in the database.

Additionally or alternatively, the analytics server may store SKU information (step 319) based on dimensions determined from other warehouse operations. For instance, a shipping container containing the SKU may be weighed, and the weight of the package may be stored.

Additionally or alternatively, in the event that the inspection reveals that the product dimensions have changed, the analytics server may store the new product measurements and/or communicate with one or more databases (step 323) to update the databases. The databases may be the databases of the vendor (databases 110 in FIG. 1).

Referring back to FIG. 3A, in step 312, the analytics server may monitor the SKUs on the list. Monitoring the SKUs may include storing tracking information, such as the time/date of the most recent exception, the time/date of the first exception, the number of clear (no issue) warehouse tasks involving the SKU since the first exception, the number of exceptions in warehouse tasks involving the SKU since the first exception, and the suspicion score (e.g., the likelihood that the SKU has an undocumented/unrecorded/undetected dimension change, the probability of dimension change of the SKU).

The analytics server monitoring the SKU may transmit an alert notification to all devices (e.g., autonomous robots, automated equipment, worker devices) that are expected to use the SKU in an upcoming warehouse operation (e.g., picking, packing, replenishing), or have used the SKU in an operation. Additionally or alternatively, the analytics server may also transmit the alert notification to one or more predetermined users (e.g. supervisors, inspectors, pickers).

In decision 314, the analytics server determines, based on monitoring the SKUs on the list, whether any of the SKUs have been involved in later exceptions. A later exception may be a consecutive exception (e.g., an exception occurring at the next warehouse operation). Additionally or alternatively, the later exception may not be consecutive or sequential. For example, the analytics server may identify an exception in a first tote holding various SKUs including a SKU for a shampoo bottle. The analytics server may not identify an exception in a second tote holding various SKUs, because the various SKUs do not include the SKU for the shampoo bottle. The analytics server may identify a later exception (e.g., later in time) in a third tote holding various SKUs, because this tote does include the SKU for the shampoo bottle. The third tote is a later exception to the first tote. In some configurations, when considering only the totes having a particular product, then each later exception may be considered subsequent or sequential. However, there are situations in which intervening totes may not have an exception for that particular product even though there has been a dimension change for that particular product.

As shown in step 316, in the event a subsequent exception is not identified (by the analytics server and/or worker), the analytics server may perform a task. FIG. 3C shows an example 300c of tasks performed in response to a lack of exceptions identified, according to an embodiment. Examples of tasks performed in response to no exceptions identified may include: incrementing a non-exception counter (step 330), decreasing the suspicion score associated with the SKU (step 332), and updating the length of time of no exceptions (step 334). In step 332, the analytics server may decrease the suspicion score by a predetermined amount. For instance, the analytics server may reduce the suspicion score by 5% for each warehouse operation in which an exception is not identified. Additionally or alternatively, the analytics server may reduce the suspicion score by 10% for each day in which an exception is not identified.

Referring back to FIG. 3A, the analytics server may perform a different set of tasks if a later exception is identified (e.g., step 314). If the later exception involves a single SKU, the analytics server may immediately (e.g., without repeating steps 308-314) confirm whether the single SKU is involved with the exception and/or remove the single SKU from the suspicion list. The analytics server may instruct a device and/or worker to weigh or measure the product and compare the inspected product to stored measurements and weights of the product. Based on the comparison, if the product's dimensions changed, the analytics server may update the stored measurements of the product and remove the SKU from the list. If the product's dimensions have not changed, the analytics server may remove the SKU from the list.

The analytics server may update the list by accessing the list from the database and overwriting information in one of the data record fields of the particular SKU or populating new information for that data record. Additionally or alternatively, the analytics server may update the list by removing the data record for a SKU from the list.

FIG. 3D shows an example 300d of tasks performed in response to an exception identified, according to an embodiment. Examples of tasks performed in response to identified exceptions may include: incrementing an exception counter 331, increasing the suspicion score associated with the SKU 335, and transmitting a notification 333. In step 335, the analytics server may increase the suspicion score by a predetermined amount. For instance, the analytics server may increase the suspicion score by 5% for each warehouse operation in which an exception is identified. Additionally or alternatively, the analytics server may increase the suspicion score by 1/y, where y is the number of SKUs involved in the subsequent exception.

The analytics server may update the list with the new suspicion score by overwriting the current suspicion score associated with the SKU. The updated suspicion score may be a total suspicion score based on the previous suspicion scores (e.g., the suspicion scores associated at each exception, the suspicion scores reduced over time). For example, the total suspicion score may be the product of the suspicion score determined at the first exception (e.g., 1/x, where x is the number of SKUs involved in the first exception) and suspicion score determined at the later exception (e.g., 1/y, where y is the number of SKUs involved in the later exception).

As discussed herein, the tasks performed in steps 316, 320 may change the suspicion score, the number of exceptions, the number of non-exceptions, and the like. The analytics server re-evaluates in step 308 whether any thresholds have been satisfied. Accordingly, the analytics server determines whether a product dimension has changed by continuously verifying that the product dimensions involved in warehouse operations have not changed.

In an example, the analytics server may identify an exception (step 302). The analytics server may collect information related to the SKUs involved in the exception and create a list of SKUs involved in the exception (step 304). The analytics server may calculate a suspicion score associated with each SKU on the list, where the suspicion score is based on the number of SKUs involved in the exception (step 306). The analytics server will determine whether the suspicion score of each SKU exceeds a threshold (step 308). For a particular SKU, the analytics server may determine that the suspicion score does not exceed the threshold and that the analytics server should continue monitoring the SKU (step 312). The analytics server may identify a later exception associated with the SKU (step 314) and generate and transmit a notification of the later exception associated with the SKU to one or more users (step 320). The users will determine whether to remove the SKU from the list (e.g., the users determine that the likelihood of the dimension of the product associated with the SKU changing is small) or to continue monitoring the SKU.

In another example, the analytics server will collect information and determine whether to collect additional information or to stop collecting information. The analytics server may identify an exception (step 302). The analytics server may collect information related to the SKUs involved in the exception (step 304). The collected information may depend on the type of exception identified. As described herein, the exception may be identified by a tote being overfull. In response to the identification of the exception, the analytics server may collect information associated with the exception such as the number of SKUs in the tote, the number of expected SKUs in the tote, the date/time of the exception, the worker performing the operation associated with the exception, and the like.

Based on the information collected from the exception, the analytics server creates a list of SKUs whose product dimensions may have changed. The analytics server may calculate a suspicion score associated with each SKU on the list, where the suspicion score is based on the number of SKUs involved in the exception (step 306). The analytics server will determine whether the suspicion score of each SKU exceeds a threshold (step 308). For a particular SKU, the analytics server may determine that the SKU's suspicion score does not exceed the threshold and that the analytics server should continue monitoring the SKU (step 312). The analytics server may identify a later exception associated with the SKU (step 314) and collect additional information associated with the exception. The later exception being identified by the analytics server because a shipping container was identified to be overfull. The analytics server may collect information associated with the later exception such as the weight of the shipping container, the expected weight of the shipping container, the SKUs in the shipping container, the number of products in the container, the number of expected products in the container, the date/time of the exception, the worker performing the operation associated with the exception, and the like. The later exception may be the same type of exception identified in step 302, or the later exception may be a different type of exception.

The analytics server may increase the suspicion scores of each of the SKUs associated with the later exception (step 320), and the analytics server may determine (step 308) whether the updated suspicion scores associated with the SKUs trigger an action associated with the SKU (step 310) or warrant further monitoring of the SKU (step 312).

In one embodiment, a computer-implemented method may comprise obtaining, by a computer, product data for a plurality of products in a container in response to an occurrence of an exception associated with that container; updating, by the computer, respective dimension change suspicion scores associated with products in the container, wherein the dimension change suspicion score associated with a given product changes responsive to items of the given product being in a container associated with a later exception; and triggering, by the computer, inspection of a particular product having a dimension change suspicion score exceeding a threshold.

In another embodiment, triggering inspection of the particular product may include generating, by the computer, a notification that the dimension change suspicion score associated with the particular product in the container exceeds the threshold; and transmitting, by the computer, the notification to a device for triggering the inspection of the particular product.

In another embodiment, the notification may comprise computer-readable instructions for measurement of the particular product.

In another embodiment, the method may further comprise monitoring, by the computer, the plurality of products in the container for a second exception for a second container after the exception.

In another embodiment, the monitoring may further comprise determining, by the computer, whether a second product of the container having the exception has a second exception in the second container.

In another embodiment, the method may further comprise updating, by the computer, in response to the second exception for the second container, the suspicion score for products of a second plurality of products of the second container, the products of the second plurality of products including the particular product.

In another embodiment, the notification may be generated based upon a total probability exceeding the threshold.

In another embodiment, the suspicion score may be a probability of dimension change for the plurality of products in the container.

In another embodiment, the suspicion score may be based in part on a number of instances the particular product has been subject to an identified exception.

In another embodiment, the suspicion score for the particular product may be based in part on an amount of time since the particular product has been subject to the later exception.

In another embodiment, a system may comprise a database configured to store suspicion scores for a plurality of products; and a server comprising a processor configured to: obtain product data for a plurality of products in a container in response to an occurrence of a first exception associated with that container; update in the database respective dimension change suspicion scores associated with products in the container, wherein the dimension change suspicion score associated with a given product changes responsive to items of the given product being in a container associated with a later exception; and trigger inspection of a particular product having a dimension change suspicion score exceeding a threshold.

In another embodiment, triggering inspection of the particular product may include generating a notification that the dimension change suspicion score associated with the particular product in the container exceeds the threshold; and transmitting the notification to a device for triggering the inspection of the particular product.

In another embodiment, the processor may be further configured to monitor the plurality of products in the container for a second exception for a second container after the exception.

In another embodiment, monitoring may further comprise determining whether a second product of the container having the exception has the second exception in the second container.

In another embodiment, the processor may be further configured to update in response to the second exception for the second container, the suspicion score for products of a second plurality of products of the second container, the products of the second plurality of products including the particular product.

In another embodiment, the notification may be generated based upon a total probability exceeding the threshold.

In another embodiment, the suspicion score may be a probability of dimension change for the plurality of products in the container.

In another embodiment, the suspicion score may be based in part on a number of instances the particular product has been subject to an identified exception.

In another embodiment, the suspicion score for the particular product may be based in part on an amount of time since the particular product has been subject to the later exception.

In yet another embodiment, a non-transitory machine-readable storage medium may have computer-executable instructions stored thereon that, when executed by one or more processors, cause the one or more processors to perform operations comprising: obtaining product data for a plurality of products in a container in response to an occurrence of a first exception associated with that container; updating respective dimension change suspicion scores associated with products in the container, wherein the dimension change suspicion score associated with a given product changes responsive to items of the given product being in a container associated with a later exception; and triggering inspection of a particular product having a dimension change suspicion score exceeding a threshold.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc. are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
obtaining, by a computer, product data for a plurality of products in a container in response to an occurrence of an exception associated with that container;
updating, by the computer, respective dimension change suspicion scores associated with products in the container, wherein the dimension change suspicion score associated with a given product changes responsive to items of the given product being in a container associated with a later exception; and
triggering, by the computer, inspection of a particular product having a dimension change suspicion score exceeding a threshold.

2. The method of claim 1, where triggering inspection of the particular product includes:
generating, by the computer, a notification that the dimension change suspicion score associated with the particular product in the container exceeds the threshold; and
transmitting, by the computer, the notification to a device for triggering the inspection of the particular product.

3. The method of claim 2, wherein the notification comprises computer-readable instructions for measurement of the particular product.

4. The method according to claim 1, further comprising monitoring, by the computer, the plurality of products in the container for a second exception for a second container after the exception.

5. The method according to claim 4, wherein monitoring further comprises determining, by the computer, whether a second product of the container having the exception has a second exception in the second container.

6. The method according to claim 4, further comprising:
updating, by the computer, in response to the second exception for the second container, the suspicion score for products of a second plurality of products of the second container, the products of the second plurality of products including the particular product.

7. The method according to claim 2, wherein the notification is generated based upon a total probability exceeding the threshold.

8. The method according to claim 1, wherein the suspicion score is a probability of dimension change for the plurality of products in the container.

9. The method according to claim 1, wherein the suspicion score is based in part on a number of instances the particular product has been subject to an identified exception.

10. The method according to claim 1, wherein the suspicion score for the particular product is based in part on an amount of time since the particular product has been subject to the later exception.

11. A system comprising:
a database configured to store suspicion scores for a plurality of products; and
a server comprising a processor configured to:
obtain product data for a plurality of products in a container in response to an occurrence of a first exception associated with that container;
update in the database respective dimension change suspicion scores associated with products in the container, wherein the dimension change suspicion score associated with a given product changes responsive to items of the given product being in a container associated with a later exception; and
trigger inspection of a particular product having a dimension change suspicion score exceeding a threshold.

12. The system of claim 11, where triggering inspection of the particular product includes:
generating a notification that the dimension change suspicion score associated with the particular product in the container exceeds the threshold; and
transmitting the notification to a device for triggering the inspection of the particular product.

13. The system of claim 11, wherein the processor is further configured to monitor the plurality of products in the container for a second exception for a second container after the exception.

14. The system of claim 13, wherein monitoring further comprises determining whether a second product of the container having the exception has the second exception in the second container.

15. The system of claim 13, wherein the processor is further configured to update in response to the second exception for the second container, the suspicion score for products of a second plurality of products of the second container, the products of the second plurality of products including the particular product.

16. The system of claim 12, wherein the notification is generated based upon a total probability exceeding the threshold.

17. The system of claim 11, wherein the suspicion score is a probability of dimension change for the plurality of products in the container.

18. The system of claim 11, wherein the suspicion score is based in part on a number of instances the particular product has been subject to an identified exception.

19. The method according to claim 11, wherein the suspicion score for the particular product is based in part on an amount of time since the particular product has been subject to the later exception.

20. A non-transitory machine-readable storage medium having computer-executable instructions stored thereon that, when executed by one or more processors, cause the one or more processors to perform operations comprising:
obtaining product data for a plurality of products in a container in response to an occurrence of a first exception associated with that container;
updating respective dimension change suspicion scores associated with products in the container, wherein the dimension change suspicion score associated with a given product changes responsive to items of the given product being in a container associated with a later exception; and
triggering inspection of a particular product having a dimension change suspicion score exceeding a threshold.
